(19) United States
(12) Patent Application Publication
(10) Pub. No.: US 2013/0269821 A1
(43) Pub. Date: Oct. 17, 2013

(54) Systems And Apparatuses For Hot Gas Flow In A Transition Piece

(71) Applicants: Richard Martin DiCintio, Simpsonville, SC (US); Patrick Benedict Melton, Horse Shoe, NC (US); Daniel Jackson Dillard, Greenville, SC (US)

(72) Inventors: Richard Martin DiCintio, Simpsonville, SC (US); Patrick Benedict Melton, Horse Shoe, NC (US); Daniel Jackson Dillard, Greenville, SC (US)

(73) Assignee: General Electric Company, Schenectady, NY (US)

(21) Appl. No.: 13/446,831

(22) Filed: Apr. 13, 2012

(51) Int. Cl. F16L 9/00; B23P 17/04

(52) U.S. Cl. 138/177; 29/592

(57) ABSTRACT

Disclosed herein are methods, systems, and apparatuses for hot gas flow. In an embodiment, a transition piece comprises a surface that conforms to an approximately straight line path stretching approximately from the forward end of a transition piece to the aft end of the transition piece wherein the surface may help direct the flow of gases.

### CROSS REFERENCE TO RELATED APPLICATIONS

The subject matter disclosed in this patent application is related to the subject matter disclosed and claimed in the following U.S. Patent Application No. XXXX, Attorney Docket No. 257649/GEEN-0031, and U.S. Patent Application No. XXX, Attorney Docket No. 256748/GEEN-0032. Each of the above U.S. patent applications were filed on even day herewith and are incorporated by reference herein in their entirety.

### TECHNICAL FIELD

The subject matter disclosed herein relates generally to combustion systems and more specifically to hot gas flow.

### BACKGROUND

In a typical can annular gas turbine engine, a plurality of combustors are arranged in a generally annular array about the engine. The combustors receive pressurized air from the engine's compressor, adds fuel to create a fuel/air mixture, and combusts that mixture to produce hot gases. The hot gases exiting the combustors are utilized to turn a turbine, which is coupled to a shaft that drives a generator for generating electricity.

The hot combustion gas is conveyed from the combustor liner to the turbine by a transition piece or duct. The hot combustion gas flowing through the transition piece subjects the duct structure to very high temperatures and can lead to premature deterioration that requires repair and replacement of the transition ducts. A significant crack in an otherwise relatively undamaged transition piece may require replacement of the entire transition piece.

### BRIEF DESCRIPTION OF THE INVENTION

Disclosed herein are apparatuses, methods, and systems for hot gas flow. In an embodiment, a transition piece has a surface that conforms to an approximately straight line extending lengthwise of the transition piece from approximately a forward end and an aft end of the transition piece, wherein the surface directs the flow of gases.

In an embodiment, a system comprises a surface that conforms to an approximately straight line from approximately a forward end and an aft end of the transition piece, wherein the surface helps direct the flow of gases and a stage one nozzle, wherein the stage one nozzle adjacent to the transition piece and is shaped to conform to a line path of the surface that conforms to the approximately straight line of the transition piece.

In yet another embodiment, there is a method comprising creating an approximately straight line path from a forward end for a first transition piece to an aft end for the first transition piece and creating a surface of the first transition piece that conforms to the approximately straight line path of the first transition piece, wherein the surface helps direct the flow of gases.

This Brief Description of the Invention is provided to introduce a selection of concepts in a simplified form that are further described below in the Detailed Description. This Brief Description of the Invention is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 is an exemplary illustration of a transition piece;

FIG. 2 is an exemplary illustration of a transition piece with a straight line top panel;

FIG. 3 is an exemplary graph displaying the impact of a transition piece body angle on peak heat transfer coefficients;

FIG. 4 is an illustration of a transition piece with a maximum tangent line and a corresponding angle;

FIG. 5 is an illustration of a transition piece with a maximum tangent line and a corresponding angle;

FIG. 6 is an illustration of a transition piece with a maximum tangent line and a corresponding angle; and

FIG. 7 is an illustration of a transition piece with a maximum tangent line and a corresponding angle.

### DETAILED DESCRIPTION OF THE INVENTION

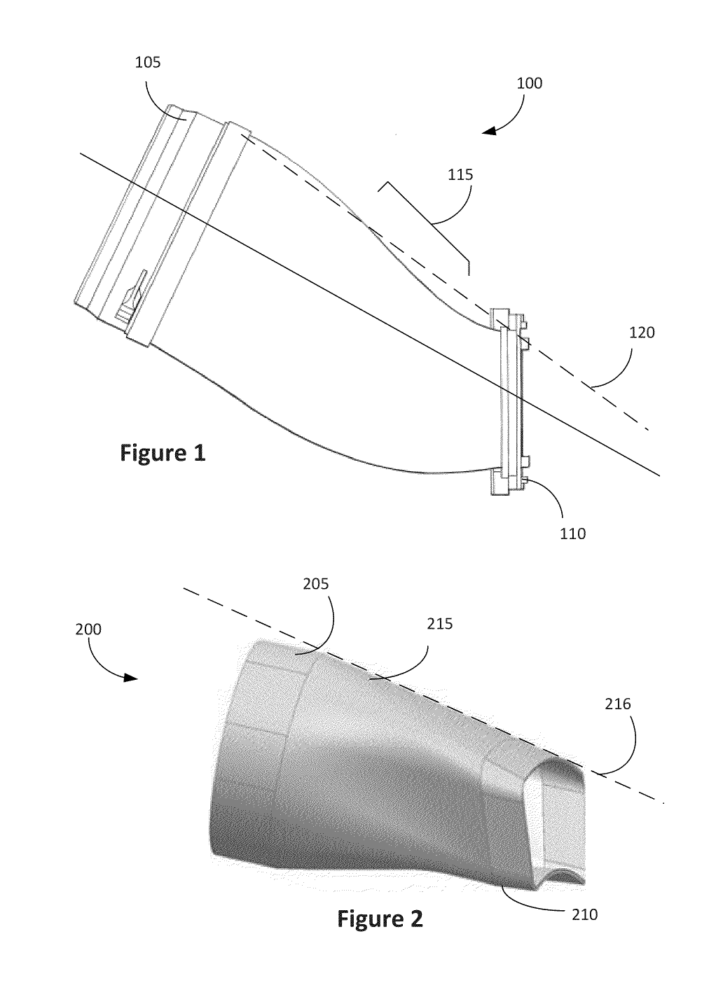

FIG. 1 is an exemplary illustration of a transition piece 100. Transition piece 100 has a forward (inlet) end 105 and an aft (outlet) end 110. Hot gases flow into inlet 105 and flow through the length of transition piece 100. The hot gases exit transition piece 100 at outlet 110. Transition piece 100 has a bend or dip 115. Bend 115 may be a life limiting section of the transition piece due to hot gases impinging on the transition piece walls. There have been many attempts to solve the life limiting issue such as placing cooling air near the bend, however these solutions typically come with significant trade-offs to turbine performance.

It has been shown that the life limiting area of a transition piece often has higher temperatures placed on it than other areas of the transition piece. These higher temperatures may cause a higher strain range for every start to stop cycle of the turbine. Over time, these strain cycles may accumulate and become the transition piece's life limit. These higher temperatures may also cause oxidation of the transition piece material. Over time, this oxidation may accumulate and become the life limit of the transition piece. Regardless of the relatively undamaged nature of the other portions of the transition piece, the entire transition piece is replaced when significant damage (e.g., cracking) is done to a particular area of the transition piece.

Experimentation through computational fluid dynamics (CFD) and other analysis techniques have shown that a transition piece with a linear cross section profile located where the highest hot side heat transfer occurs, will reduce the hot gas impingement and therefore may increase the life of the transition piece. Consequently, the transition piece may have a longer life before its removal is needed. In FIG. 1, there is a representative line 120 extending down the length of the transition piece 100. Line 120 may be terminated near the transition piece forward end that interfaces with the combustor liner. Line 120 extends the length of the transition piece through the aft frame. A internal surface along the hot gas flow of a transition piece may be modified (e.g., insertion of metal and/or manipulation of a transition piece wall) or created (e.g., from an original mold) to conform to the straight line 120. As implemented a straight line may be at any circumferential location of the transition piece.

FIG. 2 is an exemplary illustration of a transition piece implementing a linear top dead center (TDC) transition between a forward end 205 and aft end 210. The forward end 205 may be round and the aft end 210 may have a rectangular shape. The transition piece at 215 near the top may conform to a straight line 216 run longitudinally from forward end 205 to aft end. The bottom and sides of the transition piece 200 may be shaped to maintain a particular cross sectional area while keeping the top of the transition piece 215 straight.

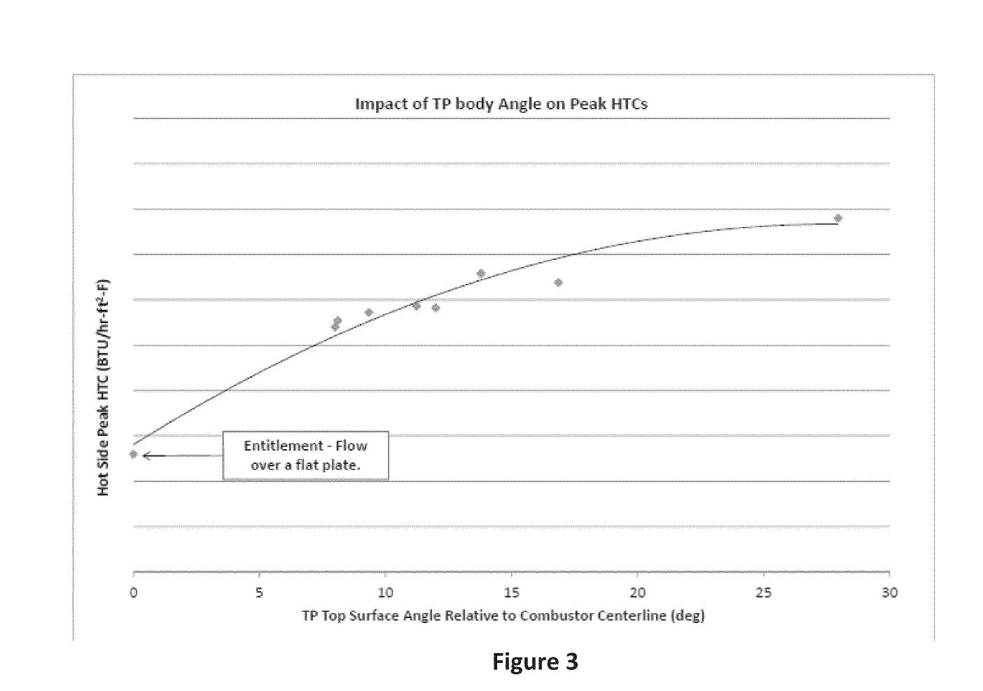

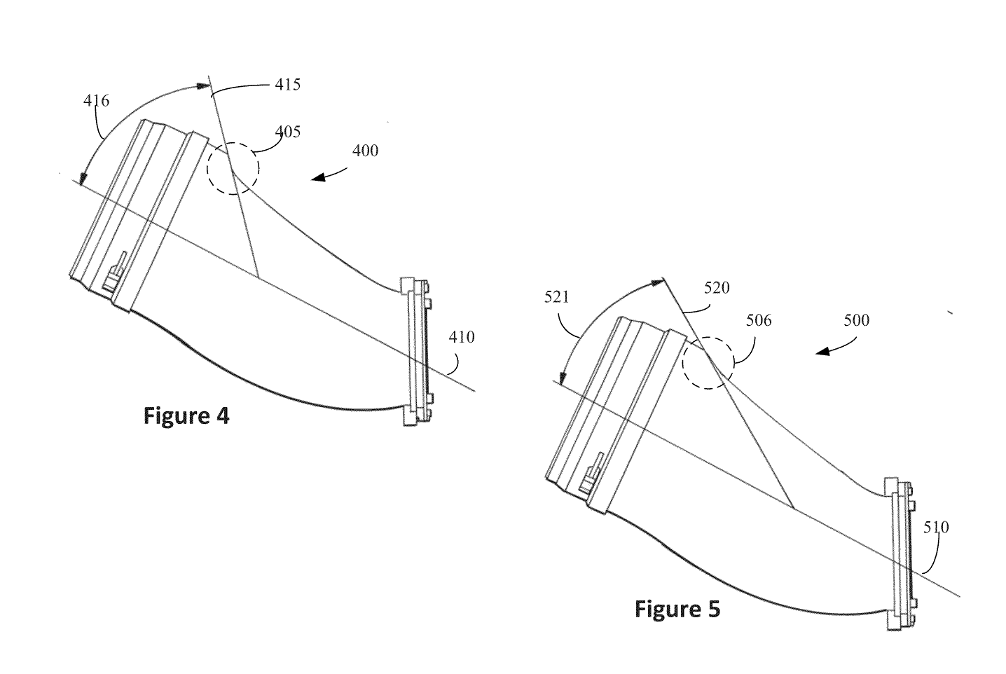

FIG. 3 is an exemplary graphical illustration of the impact of transition piece body angle on peak heat transfer coefficients (HTC). As shown in FIG. 3, the larger the angle of the top panel relative to the center line of the combustor, the higher the hot side peak HTC. The angle is formed from the maximum tangent line of the contour. The maximum tangent lines mentioned herein are representative of the tangent line for a particular contour that would create a maximum angle with a center line of a combustor. So if there is a large dip in the panel, it will form a large angle between the tangent line of the dip and the combustor center line.

Peak HTC may be controlled by altering the maximum tangent line angle, therefore a straight line surface as in FIG. 2 at 216 has a maximum tangent line that is parallel with the surface (e.g., at 216) line itself and has the smallest tangent line angle possible and the smallest peak HTC. Keep in mind that the combustor centerline which runs through the transition piece represents the direction of the hot gas flow. So the greater the maximum tangent line angle is to the combustor centerline, the greater the impingement of the hot gas into the TP wall. FIG. 3 shows that the greater the tangent line angle the greater the hot gas impingement (or crash) into the TP wall which may reduce the life of the TP.

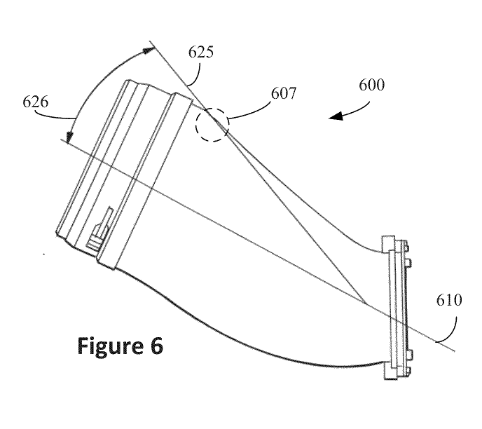

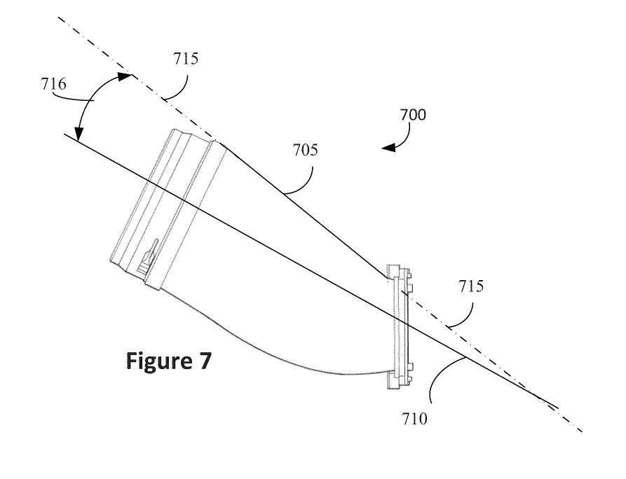

FIGS. 4, 5, and 6 are illustrations of transition pieces with maximum tangent lines and corresponding angles (not to scale). The transition piece 400 has a contour 405 that corresponds to a tangent line 415. The transition piece 500 has a contour 506 that corresponds to a tangent line 520. The transition piece 600 has a contour 607 that corresponds to a tangent line 625. The transition piece 700 has a surface 705 that corresponds to a tangent line 715. Line 410, 510, and 610, 710 correspond to the center line of an adjacent combustor. Angle 416 corresponds to the maximum angle formed for contour 405 by tangent line 415 and center line 410. Angle 521 corresponds to the maximum angle formed for contour 506 by tangent line 520 and center line 510. Angle 626 corresponds to the maximum angle formed for contour 607 by tangent line 625 and center line 610. Angle 716 corresponds to the maximum angle formed for contour 705 by tangent line 715 and center line 710. Angle 416 is larger than angle 521, angle 521 is larger than angle 626, and angle 626 is larger than angle 716. As discussed herein, the heat transfer coefficient (HTC) related to the contour that corresponds to tangent line 415 (hereinafter HTC-415) is greater than the HTC corresponding to the contour of tangent line 520 (hereinafter HTC-520). HTC-520 is greater than the HTC corresponding to the contour of the tangent line 625 (hereinafter HTC-625). HTC-625 is greater than the HTC corresponding to the contour of the tangent line 716 (hereinafter HTC-716). Since the peak HTC may be controlled by the maximum tangent line angle, a straight line maximum tangent line from aft end to forward end with a minimal tangent line angle is contemplated for relatively small peak HTCs and a longer life of the transition piece.

FIGS. 4, 5, and 6 highlight a contour and a corresponding maximum tangent line. In prior art embodiments, several contours may be found along the length of a transition piece from forward end to aft end with usually a substantial contour or bend near the aft end, as shown in FIG. 1. FIG. 7 illustrates a transition piece that has a surface that conforms to a straight line. Straight surface line 705 of transition piece 700 shows zero curvature along its length. In an embodiment, a surface of a transition piece that conforms to a straight line may have approximately zero curvature, which may minimize peak HTCs.

In an embodiment, the straight line from the transition piece may continue so that intervening apparatuses conform to the straight line that may extend into, but then terminate within the S1N. CFD and other analysis has shown that if a straight line transition piece, as disclosed herein, is used in conjunction with a S1N that continues the top panel linear alignment; additional benefits in lengthening the life of the transition piece are gained with regard to the life of the transition piece. The straight line may start near the end of the liner interface and extend into the S1N of the hot gas path. The straight line as disclosed herein may be substantially straight and create a minimal angle between the center line and the maximum tangent line angle of the TP.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. While examples disclosed herein apply to the top panel, it may apply to the sides and bottom as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A transition piece that comprises a surface that conforms to an approximately straight line extending lengthwise of the transition piece from approximately a forward end and an aft end of the transition piece, wherein the surface helps direct the flow of gases.

2. The transition piece of claim 1, wherein the surface that conforms to the approximately straight line a separate attachment to the transition piece.

3. The transition piece of claim 1, wherein the surface that conforms to the approximately straight line is located at a top dead center of the transition piece.

4. The transition piece of claim 1, wherein the surface that conforms to the approximately straight line is located at a top of the transition piece.

5. The transition piece of claim 1, wherein the surface that conforms to the approximately straight line is located at a side of the transition piece.

6. The transition piece of claim 1, wherein the surface that conforms to the approximately straight line is located at a bottom of the transition piece.

7. The transition piece of claim 1, wherein the transition piece is adjacent to a stage one nozzle that has a shape that conforms to a line path of the surface that conforms to the approximately straight line.

8. A system comprising:
a transition piece that comprises a surface that conforms to an approximately straight line from approximately a forward end and an aft end of the transition piece, wherein the surface helps direct the flow of gases; and
a stage one nozzle, wherein the stage one nozzle adjacent to the transition piece and is shaped to conform to a line path of the surface that conforms to the approximately straight line of the transition piece.

9. The system of claim 8, further comprising an intervening apparatus, wherein the intervening apparatus is along the path of the forward end of the transition piece and an end of the stage one nozzle, the intervening apparatus is shaped to conform to the straight line path of the surface that conforms to the approximately straight line of the transition piece.

10. The system of claim 8, wherein the surface that conforms to the approximately straight line of the transition piece is a separate attachment to the transition piece.

11. The system of claim 8, wherein the surface that conforms to the approximately straight line of the transition piece is located at a side of the transition piece.

12. The system of claim 8, wherein the surface that conforms to the approximately straight line of the transition piece is located at a top of the transition piece.

13. The system of claim 8, wherein the surface that conforms to the approximately straight line of the transition piece is located at a top dead center of the transition piece.

14. The system of claim 8, wherein the surface that conforms to the approximately straight line of the transition piece is located at a bottom of the transition piece.

15. The system of claim 8, wherein the surface that conforms to the approximately straight line of the transition piece is located at a side of the transition piece.

16. A method comprising:
creating an approximately straight line path from a forward end for a first transition piece to an aft end for the first transition piece; and
creating a surface of the first transition piece that conforms to the approximately straight line path of the first transition piece, wherein the surface helps direct the flow of gases.

17. The method of claim 16, further comprising:
creating a second transition piece that conforms to the surface of the first transition piece that conforms to the approximately straight line path of the first transition piece.

18. The method of claim 16, wherein the approximately straight line path is a separate attachment to the transition piece.

19. The method of claim 16, wherein the created section of the first transition piece is located on the top of the transition piece.

20. The method of claim 16, further comprising:
creating a section of a stage one nozzle that conforms to the approximately straight line path, wherein the stage one nozzle is adjacent to the first transition piece.
